(19) United States
(12) Patent Application Publication
(10) Pub. No.: US 2020/0020991 A1
(43) Pub. Date: Jan. 16, 2020

(54) SYSTEM AND METHOD FOR CHARGE PROTECTION OF A LITHIUM-ION BATTERY

(71) Applicant: TOYOTA MOTOR EUROPE, Brussels (BE)

(72) Inventors: Yuya ISHIHARA, Brussels (BE); Yuki KATOH, Brussels (BE)

(73) Assignee: TOYOTA MOTOR EUROPE, Brussels (BE)

(21) Appl. No.: 16/315,062

(22) PCT Filed: Mar. 31, 2017
(86) PCT No.: PCT/EP2017/057738

§ 371 Date: Jan. 3, 2019

(51) Int. Cl. H01M 10/44; H01M 10/0525; H01M 10/48; H01M 10/0562

(52) U.S. Cl. CPC H01M 10/448; H01M 10/0562; H01M 10/48; H01M 10/0525

(57) ABSTRACT

A method for controlling a charge process of a solid-state battery having a sulfur-based positive electrode is provided. The method includes monitoring the solid-state battery for production of sulfur fluid, and terminating a flow of charge current when sulfur fluid is detected.

### FIELD OF THE DISCLOSURE

The present disclosure is related to solid-state, lithium-based batteries or cells, and more particularly to protective measures for such batteries having a sulfur-based positive electrode.

### BACKGROUND OF THE DISCLOSURE

Lithium-based batteries are part of a family of rechargeable battery types in which lithium ions move from the negative electrode to the positive electrode during discharge and from the positive electrode to the negative electrode when charging.

There are various types of lithium-based batteries, and interest has arisen in solid-state type batteries in recent years. In such batteries, an electrolyte of the battery, previously a liquid or gel, is replaced by a solid material. For example, JP 2011-028883 discloses a secondary battery with a lithium-ion-conductive nonaqueous electrolyte. Such solid state batteries tend to have improvements in performance as a temperature increases.

It has been demonstrated that batteries, e.g., a lithium-ion battery in which the positive electrode comprises sulfur (S), have a promising energy density that is higher than many other types of lithium-based batteries. Further, because of the abundance and relatively low cost of sulfur, these batteries can be produced with significant savings over other battery technologies.

For example, JP 2004-095243 discloses a lithium-based secondary battery, where sulfur functions as the positive electrode active material, the whole solid-state lithium battery being designed to operate essentially at room temperature.

However, during a charging process of a lithium-ion battery having a sulfur-based positive electrode, sulfur (S) is produced at the positive electrode. In addition, temperature increases during a charging process and sulfur begins to sublime at 102° C., and melts at 115° C. If, for example, as a result of puncture or overcharging, the battery begins to overheat, the sulfur may sublime and/or melt to a liquid. If fluidized sulfur reaches the negative electrode, an exothermic reaction can occur, thereby resulting in battery damage and/or additional undesirable consequences.

### SUMMARY OF THE DISCLOSURE

The present inventors have recognized that it is desirable to control a charging process of a lithium-ion, solid-state battery having a sulfur-based positive electrode, to prevent sublimation and/or melting of the sulfur such that it cannot reach the negative electrode of the solid-state battery.

Therefore, according to embodiments of the present disclosure, a method of controlling a charge process of a battery having a sulfur-based positive electrode is provided. The method includes monitoring the battery for production of sulfur fluid, and terminating a flow of charge current when sulfur fluid is detected.

Based on the described method, it is possible to avoid battery damage and possibly other undesirable consequences resulting from a sulfur reaction with materials of a negative electrode.

The monitoring may be performed by a sulfur fluid sensor.

The monitoring may include measuring a resistance of a copper wire within a case of the battery. When the resistance of the copper wire increases more than a predetermined amount, the presence of sulfur fluid may be determined to exist (i.e., positive detection).

According to further embodiments of the disclosure, a battery charger for a lithium-sulfur battery is provided. The battery charger includes a current providing section configured to provide current to the lithium-sulfur battery, a monitoring section configured to monitor the lithium-sulfur battery for production of sulfur fluid, and a controller configured to terminate provision of current to the battery when fluidized sulfur is detected.

Based on the described charger, it is possible to avoid battery damage and possibly other undesirable consequences resulting from a sulfur reaction with materials of a negative electrode.

According to still further embodiments of the disclosure, a use of a battery charger as described above, for charging a battery comprising a sulfur-based positive electrode and a sulfur fluid sensor is provided. The sulfur fluid sensor preferably comprises a copper wire of predetermined resistance, i.e., having a predetermined cross-sectional area and length.

It is intended that combinations of the above-described elements and those within the specification may be made, except where otherwise contradictory.

The accompanying drawings, which are incorporated in and constitute a part of this specification, illustrate embodiments of the disclosure and together with the description, and serve to explain the principles thereof.

### BRIEF DESCRIPTION OF THE DRAWINGS

FIG. 1 shows a schematic representation of an exemplary lithium-ion cell having a positive electrode comprising sulfur;

FIG. 2 shows a flowchart of an exemplary method for charging a solid-state battery having a sulfur-based positive electrode according to embodiments of the disclosure;

FIG. 3 shows a flowchart of an exemplary method for detecting sulfur fluid within the solid state battery of FIG. 1;

FIG. 4 shows a graphical representation of resistance of copper vs copper sulfide; and

FIG. 5 is a high-level representation of an exemplary charger configuration for charging a lithium-ion cell having a positive electrode comprising sulfur.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

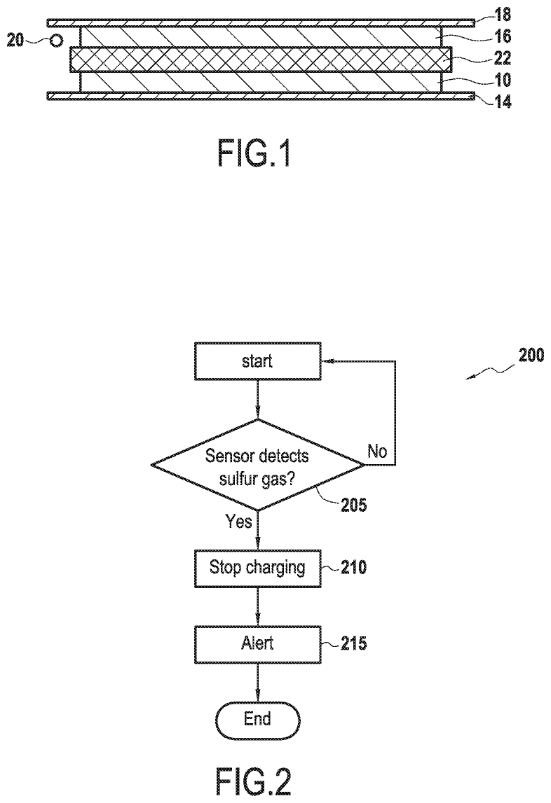

FIG. 1 shows a schematic representation of an exemplary all solid-state, lithium cell 10. The lithium cell 10 includes a negative electrode 12 fixed on an negative current collector 14 and a positive electrode 16 fixed on a positive current collector 18. The negative electrode 12 and the positive electrode 16 are separated by a solid electrolyte 22 with which the negative electrode 12 and positive electrode 16 are directly in contact. In addition, a sulfur fluid sensor 20 is provided, within the cell 10, for example, near positive electrode 16.

According to exemplary embodiments, positive electrode 16 comprises sulfur in an amount greater than about 70 percent by weight.

Negative electrode 12 may comprise, for example, Carbon, Si, Li metal, Li₄Ti₅O₁₂, TiO₂, Sn, Al etc., as desired based on a particular battery design.

Each of the positive and negative current collectors 14 and 18 may comprise, for example, Cu, Al, Ni, stainless steel, etc., and the material may be the same for each, or may differ based on a desired battery design.

Solid electrolyte 22 of cell 10 may comprise a binder, e.g., a polymer, in addition to an electrolyte compound comprising sulfur. For example, solid electrolyte 22 may comprise a polyethylene oxide (PEO) binder with LiCF₃SO₃ as the electrolyte. Additional examples include, a polyphenyleneoxide (PPO) binder with a LiCF₃SO₃ electrolyte, a Poly[EO+2(2-methoxyethoxy)ethylglycidylether(MEEGE)] binder with an LiCF₃SO3 electrolyte, polysiloxane binder with LiClO4 electrolyte, Li2S-952 electrolyte, Li0.35La0.55TiO3 (LLTO) electrolyte, and/or Li2S-GeS2-P2S5 electrolyte, etc. One of skill will recognize that these compounds may be used in combination or individually, as desired, and any of the electrolytes used with any of the polymer binders.

Sulfur fluid sensor 20 is configured to sense the presence of sulfur gas and/or liquid within a case of the cell 10. Sulfur fluid sensor is configured to output a signal indicating a detection value, for example, a sulfur fluid sensor 20 may comprise a copper wire, of which the resistance is monitored continuously or at predetermined intervals, such that upon an increase in resistance, it may be inferred that sulfur fluid has come into contact with the copper wire.

Importantly, the resistivity of copper is known, and resistance of a wire depends on the cross-sectional area and length of the wire, along with the resistivity, as shown at equation 1).

Total Resistance R=Resistivity×Length/Area (1)

When copper is exposed to sulfur liquid and/or gas, it readily reacts to form Cu₂S and/or CuS. Further, as shown at FIG. 4, the resistivity of CuS (and that of Cu₂S) is substantially higher than that of pure copper. Therefore, by monitoring a resistance of the copper wire, it is possible to determine the presence of sulfur liquid and/or gas based on a resistance of the wire exceeding a threshold value R₀, for example. In other words, when the previously known resistance R of a copper wire increases to exceed the value R₀, it is determined that the wire has reacted, or is currently reacting with sulfur gas and/or liquid.

Sulfur fluid sensor 20 may be positioned within a case (not shown) of the battery. For example, sulfur fluid sensor 20 may be provided near positive electrode 16 and affixed to an internal portion of the battery case.

Depending on an intended, or installed, orientation of the battery, sulfur fluid sensor 20 may be positioned in a location most likely to be exposed earliest to sulfur fluid upon production thereof. For example, because sulfur in a gas or liquid phase is denser than air, sulfur fluid sensor 20 may be positioned at a bottom of the battery case, as determined when the battery case is in a final installed position. One of skill will recognize that various locations within the battery case may be suitable for placement of sulfur fluid sensor 20, and that any such location is intended to fall within the scope of the present disclosure.

FIG. 5 is a high-level representation of an exemplary charger configuration for charging a lithium-ion cell having a positive electrode 16 comprising sulfur. Charger 50 may comprise, among others, a monitoring portion 80, a current providing portion 75, a power input 60, and a controller 70.

Power input 60 may be configured to receive power as either AC or DC current, for example, from the mains or other suitable power source, such as a battery. Power input 60 may be configured to convert AC current received to DC current, for example, or to provide AC current to another section of charger 50, for example, current providing section 75, for such a conversion.

Current providing section 75 may be configured to provide a current to a device external to charger 50, for example, cell 10. Current providing section 75 may be configured to set a provided current at a value as determined by controller 70, as will be discussed below, and may further be enabled to stop a flow of current from charger 50, as desired. One of skill in the art will recognize that lithium-ion batteries are typically charged with a current limiting control to avoid undesirable consequences with the battery. Current providing section 75 may be configured to provide such functionality in conjunction with controller 70.

Monitoring section 80 may be configured to monitor resistance of a copper wire and/or a signal provided by sulfur fluid sensor 20. For example, monitoring section 80 may be configured to provide a predetermined voltage and current to sulfur fluid sensor 20, and using the equation R=V/I, determine when the measured resistance R exceeds the threshold value R₀, thereby determining a presumption of the presence of sulfur fluid. Alternatively, sulfur fluid sensor 20 may be configured to provide a particular signal to monitoring section 80 such that monitoring section 80 may determine from the signal the presence of sulfur fluid.

Controller 70 may be configured to control the operation of charger 50, for example, setting an output current and voltage from charger 50, and to terminate charging current when, for example, a full charge level is reached or sulfur fluid is detected in the battery case.

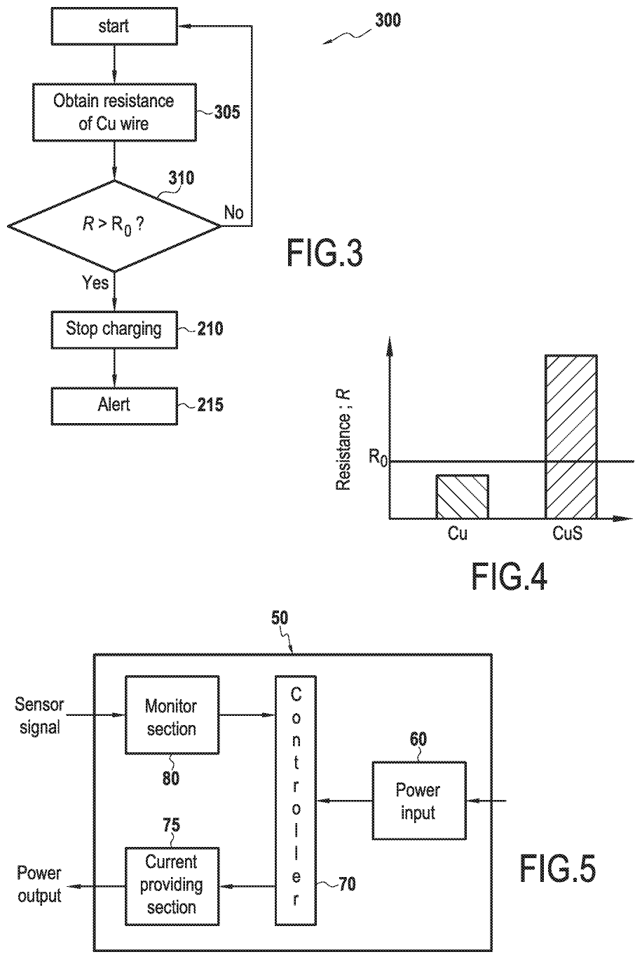

FIG. 2 shows a flowchart 200 of an exemplary method for charging a solid-state battery having a sulfur-based positive electrode, while FIG. 3 shows a flowchart 300 of an exemplary method for detecting sulfur fluid within the solid state battery of FIG. 1.

During charging of cell 10, sulfur fluid sensor 20 may be continually monitored by, for example, controller 70, to determine whether sulfur fluid is being produced as a result of the charging process (step 205). When sulfur fluid is detected (step 205: Yes), controller 70 terminates a flow of current to cell 10 to stop the charging process (step 210). An alert may then be made to notify an operator, for example, to indicate that charging has been stopped (step 215).

In FIG. 3, the process of monitoring for sulfur fluid production is detailed (i.e., step 205 of FIG. 2). The resistance of a copper wire is continuously monitored, or checked at predetermined intervals (e.g., 2 ms) (step 305), for example by monitoring a signal (e.g., resistance) output by sulfur fluid sensor 20. When it is determined that the monitored signal, e.g., resistance R increases above a threshold value R₀, (step 310: yes) the controller 70 stops the current flow from current providing section 75 (step 210) and an alert is output (step 215). Otherwise, the signal from sulfur fluid sensor remains monitored while charging is underway.

The method and system are described in terms of a single cell 10. However, it may be easily adapted for batteries having multiple cells 10.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A method for controlling a charge process of a solid-state battery having a sulfur-based positive electrode, the method comprising:
monitoring the solid-state battery for production of sulfur fluid; and
terminating a flow of charge current when sulfur fluid is detected.

2. The method according to claim 1, wherein the monitoring is performed by a sulfur fluid sensor.

3. The method according to claim 1, wherein the monitoring comprises measuring a resistance of a copper wire within a case of the solid-state battery.

4. The method according to claim 3, wherein when the resistance of the copper wire increases more than a predetermined amount, the presence of sulfur fluid is detected.

5. A battery charger for a solid state battery having a sulfur-based positive electrode, the battery charger comprising:
a current providing section configured to provide current to the solid-state battery;
a monitoring section configured to monitor the solid-state battery for production of sulfur fluid; and
a controller configured to terminate a flow of current to the solid-state battery when production of fluidized sulfur is detected.

6. Use of a battery charger according to claim 5, for charging a solid-state battery comprising a sulfur-based positive electrode and a sulfur fluid sensor, the sulfur fluid sensor preferably comprising a copper wire of predetermined resistance.

7. The method according to claim 2, wherein the monitoring comprises measuring a resistance of a copper wire within a case of the solid-state battery.
